(19) United States
(12) Patent Application Publication
(10) Pub. No.: US 2025/0046171 A1
(43) Pub. Date: Feb. 6, 2025

(54) Emergency Alert Device

(71) Applicant: Jessica Nelson, Kearney, NE (US)

(72) Inventor: Jessica Nelson, Kearney, NE (US)

(21) Appl. No.: 18/610,800

(22) Filed: Mar. 20, 2024

Related U.S. Application Data
(60) Provisional application No. 63/516,933, filed on Aug. 1, 2023.

(51) Int. Cl. G08B 21/02

(52) U.S. Cl. CPC G08B 21/0291

(57) ABSTRACT

An emergency alert device is provided. The device can be used by a young child to alert emergency services and/or a parent/guardian of an emergency. To do so, the device is comprised of at least one button that can be pressed in the event of an emergency. Pressing the button automatically alerts a contact (emergency services and/or a parent) and notifies the contact of the GPS location of the device (and user). In a further embodiment, the device can also be used as a motion sensor for home security and alerting purposes and is comprised of a motion sensor. In this embodiment, the device produces an audible sound when motion is detected.

### CROSS-REFERENCE TO RELATED APPLICATION

The present application claims priority to, and the benefit of, U.S. Provisional Application No. 63/516,933, which was filed on Aug. 1, 2023, and is incorporated herein by reference in its entirety.

### FIELD OF THE INVENTION

The present invention relates generally to the field of alerting devices. More specifically, the present invention relates to an emergency alert device that can be used by a young child to alert emergency services and/or a parent/guardian of an emergency. The device can also be used as a motion sensor for home security and alerting purposes. Accordingly, the present disclosure makes specific reference thereto. Nonetheless, it is to be appreciated that aspects of the present invention are also equally applicable to other like applications, devices, and methods of manufacture.

### BACKGROUND

Young children, who often do not possess their own smartphone, face a significant risk in emergency situations due to their inability to contact emergency services. This vulnerability is compounded when they rely on gadgets that offer low connectivity and reliability, which can be a critical hindrance in times of urgent need. As a result, the inability to promptly call for help during emergencies puts said children in potential danger. Furthermore, parents often face challenges in monitoring their children's whereabouts and well-being when they are not in close proximity, such as during school hours, play dates, or other activities away from home. This lack of constant supervision adds another layer of concern regarding child safety.

In addition to the issues faced by young children, people in general may find themselves in vulnerable situations due to financial constraints. The high cost of sophisticated security systems can be prohibitive for many, leaving them without adequate protection in their homes. This is particularly concerning for individuals who spend significant time alone at home or for those who must leave their homes unattended for extended periods. The lack of affordable and effective security measures thus poses a significant risk to their safety and security, leaving them exposed to potential threats and dangers.

Therefore, there exists a long-felt need in the art for an alert device. There also exists a long-felt need in the art for an emergency alert device that can be used by a young child to notify emergency services and/or parents/guardians of an emergency situation. Further, there exists a long-felt need in the art for an alert device that can be used as a low-cost home security system. More specifically, there exists a long-felt need in the art for an alert device that can be used as a low-cost home security system that alerts a user to motion within a home.

The subject matter disclosed and claimed herein, in one embodiment thereof, comprises an emergency alert device. The device can be used by a young child to alert emergency services and/or a parent/guardian of an emergency. To do so, the device is comprised of at least one button that can be pressed in the event of an emergency. Pressing the button automatically alerts a contact (emergency services and/or a parent) and notifies the contact of the GPS location of the device (and user). In a further embodiment, the device can also be used as a motion sensor for home security and alerting purposes and is comprised of a motion sensor. In this embodiment, the device produces an audible sound when motion is detected.

In this manner, the emergency alert device of the present invention accomplishes all the foregoing objectives and provides an alert device. The device can be used by a young child to notify emergency services and/or parents/guardians of an emergency situation. Further, the device can be used as a low-cost home security system that alerts a user to motion within a home.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an emergency alert device. The device is comprised of an emergency alert device that allows a user to alert emergency services and/or at least one secondary individual of an emergency. In another embodiment, the device also alerts a user to motion.

The device is comprised of a body that may resemble any item, object, animal, character, shape, symbol, etc., known in the art. However, the body preferably resembles a bee. The body is comprised of at least one button which may be covered by at least one covering of the body such that the button cannot be inadvertently pressed in one embodiment. The body is comprised of at least one button. The button may be comprised of an emergency button that when pressed alerts emergency services (ex. police, fire, EMT, etc.,) of the GPS location of the device (and user) via at least one GPS tracker of the device. The button may also be comprised of at least one contact button that when pushed notifies a secondary user (such as at least one parent of a child using the device) of the location of the device (and user) via a mobile application of the device. The mobile application allows a user to view the location of the device via a map interface of any map type and style and also alerts a user when either button has been pressed via a call, a text, an email, a push notification, etc.

In one embodiment, the device is comprised of at least one fastener that attaches to the body in a removable or fixed manner. In this embodiment, the device can be attached to a doorknob via the fastener. In this embodiment, the device is comprised of at least one sensor that is preferably a motion sensor that detects movement of the device (and doorknob) and/or motion in a specific radius of the device. If movement is detected by the sensor, the sensor communicates to the mobile application such that the application alerts a user of the application (i.e., a parent) via a call, a text, an email, a push notification, etc. In this embodiment, the device may also be comprised of at least one speaker that produces a sound, an alarm, etc., when the sensor detects motion.

The mobile application also allows a user to input contacts for emergency services and secondary contacts that correspond to the contact button. The contacts may be in the form of a phone number and/or account user of the application. In order to communicate with the application the device is comprised of at least one transmitter. The transmitter is preferably a wireless transmitter that allows the device to be in wireless electrical communication with the mobile application, and wherein the mobile application is installed on a smart device such as, but not limited to, a cellphone, a computer, a tablet, etc.

The present invention is also comprised of a method of using the device. First, a device is provided comprised of a body comprised of at least one button, at least one GPS tracker, at least one transmitter, and a mobile application. Then, a user can input/select a contact to assign for the emergency button and a contact button. In the event of an emergency, a user can press the emergency button and/or the contact button to alert said contacts of the GPS location of the device and the user via the GPS tracker of the device. Said contacts may be alerted by the mobile application itself by an associated outside call, text, email, notification, etc.

The present invention is also comprised of a second method of using the device. First, a device is provided comprised of a body comprised of at least one button, at least one sensor, at least one fastener, at least one speaker, at least one GPS tracker, at least one transmitter, and a mobile application. Then, a user can input/select a contact to assign for the emergency button and a contact button. Next, the body can be attached to a surface, such as, but not limited to, the surface of a door or door knob, via the fastener wherein once the sensor detects motion an alarm will sound from the speaker of the device. In the event of an emergency, a user can then press the emergency button and/or the contact button to alert said contacts of the GPS location of the device and the user via the GPS tracker of the device. Said contacts may be alerted by the mobile application itself 170 for by an associated outside call, text, email, notification, etc.

Accordingly, the emergency alert device of the present invention is particularly advantageous as it provides an alert device. The device can be used by a young child to notify emergency services and/or parents/guardians of an emergency situation. Further, the device can be used as a low-cost home security system that alerts a user to motion within a home. In this manner, the emergency alert device overcomes the limitations of existing child emergency notification devices and security systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an emergency alert device of the present invention in accordance with the disclosed architecture;

FIG. 2 illustrates a graphical view of a mobile application of one potential embodiment of an emergency alert device of the present invention in accordance with the disclosed architecture;

FIG. 3 illustrates a flowchart of a method of using one potential embodiment of an emergency alert device of the present invention in accordance with the disclosed architecture; and

FIG. 4 illustrates a flowchart of a method of using one potential embodiment of an emergency alert device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an alert device. There also exists a long-felt need in the art for an emergency alert device that can be used by a young child to notify emergency services and/or parents/guardians of an emergency situation. Further, there exists a long-felt need in the art for an alert device that can be used as a low-cost home security system. More specifically, there exists a long-felt need in the art for an alert device that can be used as a low-cost home security system that alerts a user to motion within a home.

The present invention, in one exemplary embodiment, is comprised of an emergency alert device. The device is comprised of an emergency alert device that allows a user to alert emergency services and/or at least one secondary individual of an emergency. In another embodiment, the device also alerts a user to motion.

The device is comprised of a body that may resemble any item, object, animal, character, shape, symbol, etc., known in the art but preferably resembles a bee. The body is comprised of at least one button which may be covered by at least one covering of the body such that the button cannot be inadvertently pressed in one embodiment. The body is comprised of at least one button. The button may be comprised of an emergency button that when pressed alerts emergency services (ex. police, fire, EMT, etc.,) of the GPS location of the device (and user) via at least one GPS tracker of the device. The button may also be comprised of at least one contact button that when pushed notifies a secondary user (such as at least one parent of a child using the device) of the location of the device (and user) via a mobile application of the device. The mobile application allows a user to view the location of the device via a map interface of any map type and style and also alerts a user when either button has been pressed via a call, a text, an email, a push notification, etc.

In one embodiment, the device is comprised of at least one fastener that attaches to the body in a removable or fixed manner. In this embodiment, the device can be attached to a doorknob via the fastener. In this embodiment, the device is comprised of at least one sensor that is preferably a motion sensor that detects movement of the device (and doorknob) and/or motion in a specific radius of the device. If movement is detected by the sensor, the sensor communicates to the mobile application such that the application alerts a user of the application (i.e., a parent) via a call, a text, an email, a push notification, etc. In this embodiment, the device may also be comprised of at least one speaker that produces a sound, an alarm, etc., when the sensor detects motion.

The mobile application also allows a user to input contacts for emergency services and secondary contacts that correspond to the contact button. The contacts may be in the form of a phone number and/or account user of the application. In order to communicate with the application the device is comprised of at least one transmitter. The transmitter is preferably a wireless transmitter that allows the device to be in wireless electrical communication with the mobile application, and wherein the mobile application is installed on a smart device such as, but not limited to, a cellphone, a computer, a tablet, etc.

The present invention is also comprised of a method of using the device. First, a device is provided comprised of a body comprised of at least one button, at least one GPS tracker, at least one transmitter, and a mobile application. Then, a user can input/select a contact to assign for the emergency button and a contact button. In the event of an emergency, a user can press the emergency button and/or the contact button to alert said contacts of the GPS location of the device and the user via the GPS tracker of the device. Said contacts may be alerted by the mobile application itself by an associated outside call, text, email, notification, etc.

The present invention is also comprised of a second method of using the device. First, a device is provided comprised of a body comprised of at least one button, at least one sensor, at least one fastener, at least one speaker, at least one GPS tracker, at least one transmitter, and a mobile application. Then, a user can input/select a contact to assign for the emergency button and a contact button. Next, the body can be attached to a surface, such as, but not limited to, the surface of a door or door knob, via the fastener wherein once the sensor detects motion an alarm will sound from the speaker of the device. In the event of an emergency, a user can then press the emergency button and/or the contact button to alert said contacts of the GPS location of the device and the user via the GPS tracker of the device. Said contacts may be alerted by the mobile application itself 170 by an associated outside call, text, email, notification, etc.

Accordingly, the emergency alert device of the present invention is particularly advantageous as it provides an alert device. The device can be used by a young child to notify emergency services and/or parents/guardians of an emergency situation. Further, the device can be used as a low-cost home security system that alerts a user to motion within a home. In this manner, the emergency alert device overcomes the limitations of existing child emergency notification devices and security systems known in the art.

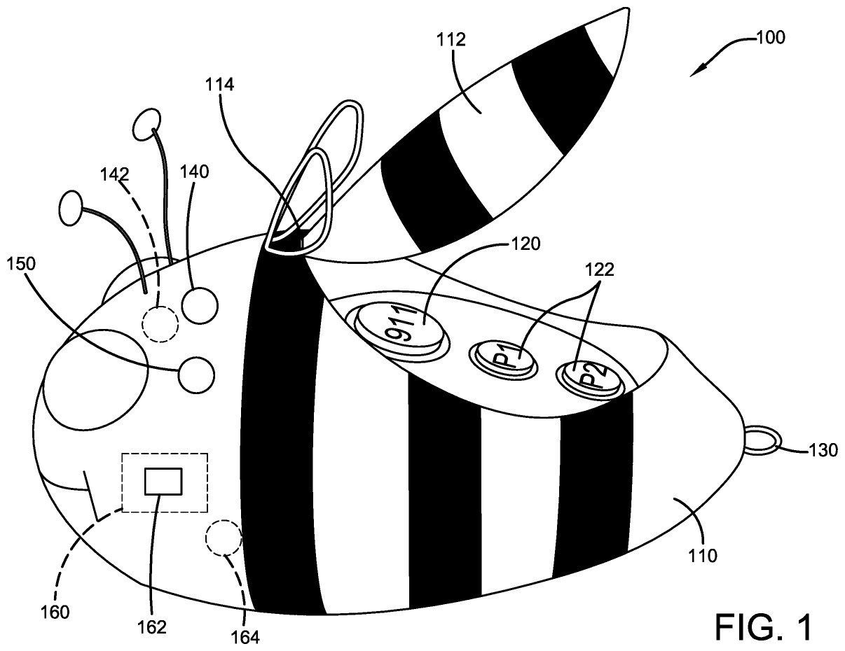

Referring initially to the drawings, FIG. 1 illustrates a perspective view of one potential embodiment of an emergency alert device of the present invention in accordance with the disclosed architecture. The device 100 is comprised of an emergency alert device that allows a user to alert emergency services and/or at least one secondary individual of an emergency. In another embodiment, the device 100 also alerts a user to motion.

The device 100 is comprised of a body 110 that is preferably made from a plastic material, metal material, etc. The body 110 may resemble any item, object, animal, character, shape, symbol, etc., known in the art. However, the body 110 preferably resembles a bee. The body 110 is comprised of at least one button which may be covered by at least one covering 112 of the body 110 such that the button cannot be inadvertently pressed in one embodiment. The covering 112 is preferably in the form of a lid that attaches to the body 110 via at least one hinge 114 (of any type known in the art).

The body 110 is comprised of at least one button. The button may be comprised of an emergency button 120 that when pressed alerts emergency services (ex. police, fire, EMT, etc.,) of the GPS location of the device 100 (and user) via at least one GPS tracker 142 of the device 100. The button may also be comprised of at least one contact button 122 that when pushed notifies a secondary user (such as at least one parent of a child using the device 100) to the location of the device 100 (and user) via a mobile application 170 of the device 100. The mobile application 170 allows a user to view the location of the device 100 via a map interface 172 of any map type and style and also alerts 174 a user when either button 120, 122 has been pressed via a call, a text, an email, a push notification, etc.

In one embodiment, the device 100 is comprised of at least one fastener 130 that attaches to the body 110 in a removable or fixed manner. The fastener 130 allows the body 110 to attach to various items, objects, surfaces, etc. The fastener 130 includes, but is not limited to, a keyring, a clip, a clasp, a magnet, a hook fastener, a loop fastener, a hook and loop fastener, a snap button fastener, a suction cup, etc.

In one embodiment, the device 100 can be attached to a doorknob via the fastener 130. In this embodiment, the device 100 is comprised of at least one sensor 140. The sensor 140 is preferably a motion sensor that detects movement of the device 100 (and doorknob) and/or motion in a specific radius of the device 100. If movement is detected by the sensor 140, the sensor 140 communicates to the mobile application 170 such that the application alerts 174 a user of the application (i.e., a parent) via a call, a text, an email, a push notification, etc. In this embodiment, the device 100 may also be comprised of at least one speaker 150 that produces a sound, an alarm, etc., when the sensor 140 detects motion.

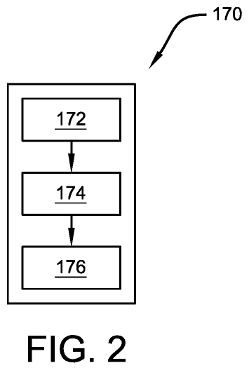

The mobile application 170 also allows a user to input contacts 176 for emergency services and secondary contacts that correspond to the contact button 122, as seen in FIG. 2. The contacts may be in the form of a phone number and/or account user of the application 170.

In order to communicate with the application 170 the device 100 is comprised of at least one transmitter 164. The transmitter 164 is preferably a wireless transmitter that allows the device 100 to be in wireless electrical communication with the mobile application 170, and wherein the mobile application is installed on a smart device such as, but not limited to, a cellphone, a computer, a tablet, etc. The transmitter 164 is preferably a Wi-Fi, Bluetooth, or cellular transmitter, or maybe any other type of wireless transmitter known in the art.

The device 100 is powered by at least one battery 160. The battery 160 may be removable or non-removable from the body 110 in different embodiments. The battery 160 may also be disposable or rechargeable. In an embodiment wherein the battery 160 is non-removable and rechargeable, the battery 160 may be comprised of at least one charging port 162 such as, but not limited to, a USB port.

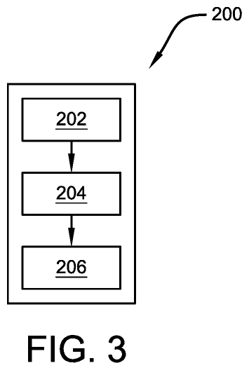

The present invention is also comprised of a method of using 200 the device 100, as seen in FIG. 3. First, a device 100 is provided comprised of a body 110 comprised of at least one button 120, 122, at least one GPS tracker 142, and at least one transmitter 164, and a mobile application 170 [Step 202]. Then, a user can input/select a contact 176 to assign for the emergency button 120 and a contact button 122 [Step 204]. In the event of an emergency, a user can press the emergency button 120 and/or the contact button 122 to alert said contacts of the GPS location of the device 100 and the user via the GPS tracker 142 of the device 100 [Step 206]. Said contacts may be alerted by the mobile application itself 170 for by an associated outside call, text, email, notification, etc.

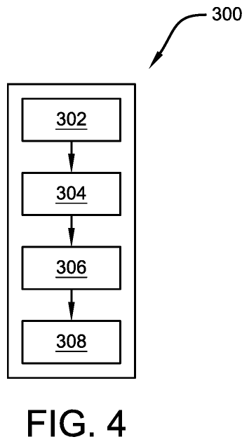

The present invention is also comprised of a second method of using 300 the device 100, as seen in FIG. 4. First, a device 100 is provided comprised of a body 110 comprised of at least one button 120, 122, at least one sensor 140, at least one fastener 130, at least one speaker 150, at least one GPS tracker 142, and at least one transmitter 164, and a mobile application 170 [Step 302]. Then, a user can input/select a contact 176 to assign for the emergency button 120 and a contact button 122 [Step 304]. Next, the body 110 can be attached to a surface, such as, but not limited to, the surface of a door or door knob, via the fastener 130 wherein once the sensor 140 detects motion an alarm will sound from the speaker 150 of the device 100 [Step 306]. In the event of an emergency, a user can then press the emergency button 120 and/or the contact button 122 to alert said contacts of the GPS location of the device 100 and the user via the GPS tracker 142 of the device 100 [Step 308]. Said contacts may be alerted by the mobile application itself 170 for by an associated outside call, text, email, notification, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency alert device” and “device” are interchangeable and refer to the emergency alert device 100 of the present invention.

Notwithstanding the foregoing, the emergency alert device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the emergency alert device 100 as shown in the FIGS. are for illustrative purposes only, and that many other sizes and shapes of the emergency alert device 100 are well within the scope of the present disclosure. Although the dimensions of the emergency alert device 100 are important design parameters for user convenience, the emergency alert device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emergency alert device comprising:
a body;
a first button position on the body;
a second button positioned on the body;
a transmitter
a GPS tracker;
a battery; and
a mobile application in wireless communication with the transmitter.

2. The emergency alert device of claim 1, wherein the body is comprised of a lid or a covering.

3. The emergency alert device of claim 2, wherein the lid or the covering attaches to the body via a hinge.

4. The emergency alert device of claim 2, wherein the lid or the covering covers the first button and the second button.

5. The emergency alert device of claim 1, wherein the first button notifies an emergency service of the GPS location of the emergency alert device when pressed.

6. The emergency alert device of claim 1, wherein the second button notifies a contact inputted by the mobile application of the GPS location of the emergency alert device when pressed.

7. The emergency alert device of claim 1, wherein the mobile application alerts a user via a call, a text, an email, or a push notification when the first button or the second button is pressed.

8. The emergency alert device of claim 1, wherein the mobile application allows a user to view the GPS location of the emergency alert device on a map interface of the mobile application.

9. An emergency alert device comprising:
a body;
a first button position on the body;
a second button positioned on the body;
a transmitter
a GPS tracker;
a sensor;
a fastener;
a battery; and
a mobile application in wireless communication with the transmitter.

10. The emergency alert device of claim 9, wherein the sensor is comprised of a motion sensor.

11. The emergency alert device of claim 9, wherein the fastener is comprised of a keyring, a clip, a clasp, a magnet, a hook fastener, a loop fastener, a hook and loop fastener, a snap button fastener, or a suction cup.

12. The emergency alert device of claim 9 further comprised of a speaker.

13. The emergency alert device of claim 12, wherein the speaker produces a sound when the sensor detects motion.

14. The emergency alert device of claim 9, wherein the first button notifies an emergency service of the GPS location of the emergency alert device when pressed.

15. The emergency alert device of claim 9, wherein the second button notifies a contact inputted by the mobile application of the GPS location of the emergency alert device when pressed.

16. The emergency alert device of claim 9, wherein the mobile application alerts a user via a call, a text, an email, or a push notification when the first button or the second button is pressed.

17. The emergency alert device of claim 9, wherein the mobile application allows a user to view the GPS location of the emergency alert device on a map interface of the mobile application.

18. A method of using an emergency alert device, the method comprising the following steps:
providing an emergency alert device comprised of a mobile application and a body comprised of a button, a GPS tracker, and a transmitter;
inputting a contact to assign the contact to the button; and
pressing the button in the event of an emergency such that the button alerts the contact of the GPS location of the emergency alert device.

19. The method of using an emergency alert device of claim 18, wherein the contact is comprised of a parent or a guardian.

20. The method of using an emergency alert device of claim 18, wherein the contact is comprised of an emergency service.
